(19) United States
(12) Patent Application Publication
(10) Pub. No.: US 2021/0109373 A1
(43) Pub. Date: Apr. 15, 2021

(54) EYEWEAR SYSTEM HAVING AN ADJUSTABLE DECLINATION ANGLE

(71) Applicant: LooLoops, LLC, Scottsdale, AZ (US)

(72) Inventors: Kent Chill Loo, Scottsdale, AZ (US); Joseph Pepe Elijio Velasquez, Tempe, AZ (US); Daniel W. Allen, Mesa, AZ (US); Joseph M. Barrett, Tempe, AZ (US)

(73) Assignee: LooLoops, LLC, Scottsdale, AZ (US)

(21) Appl. No.: 17/069,484

(22) Filed: Oct. 13, 2020

Related U.S. Application Data
(60) Provisional application No. 62/913,737, filed on Oct. 11, 2019.

(51) Int. Cl. G02C 5/14; G02C 5/10

(52) U.S. Cl. CPC G02C 5/14; G02C 5/10

(57) ABSTRACT

An eyewear system comprising an eyewear frame comprising a first side bow component and a second side bow component, an auxiliary frame comprising an auxiliary top bar, an auxiliary first side bow component and an auxiliary second side bar component, the auxiliary first side bow component and the auxiliary second side bow component pivotally coupled to the first side bow component and the second side bow component, respectively. The system further comprises a declination angle adjuster positioned proximal a bridge of the eyewear frame, the declination angle adjuster comprising a rotatable member therein, and a vertical extension member extending from the eyewear frame and at least partially into the declination angle adjuster, the vertical extension member configured to engage the rotatable member within the declination angle adjuster.

### CROSS REFERENCE TO RELATED APPLICATIONS

This application claims priority to U.S. Provisional Patent Application No. 62/913,737 filed on Oct. 11, 2019, entitled “Comfort Fit Slip-Resistant Eyewear System” to Loo, et al., the contents of which is hereby incorporated by reference in its entirety.

### BACKGROUND

### 1. Field of the Invention

Exemplary embodiments generally relate to an eyewear system design for enhanced user comfort and ease of use.

### 2. Related Art

Eyewear is generally designed to fit a pre-determined face shape and anatomical structure, which causes many wearers to experience a poor fit, particularly for eyewear systems that require a precise declination angle for proper use, such as by non-limiting example, when the eyewear system comprises one or more loupes. Conventional eyewear typically relies on a user altering an angle of the bows of the eyewear frame relative to a horizontal axis extending from the top of the user's ears in order to adjust the declination angle of the eyewear frame which results in an unstable and often uncomfortable fit.

### SUMMARY

Implementations of an eyewear system may comprise an eyewear frame comprising a first side bow component and a second side bow component, an auxiliary frame comprising an auxiliary top bar, an auxiliary first side bow component and an auxiliary second side bar component, the auxiliary first side bow component and the auxiliary second side bow component pivotally coupled to the first side bow component and the second side bow component, respectively. The system may further comprise a declination angle adjuster positioned proximal a bridge of the eyewear frame, the declination angle adjuster comprising a rotatable member therein and a vertical extension member extending from the eyewear frame and at least partially into the declination angle adjuster, the vertical extension member configured to engage the rotatable member within the declination angle adjuster.

Particular aspects may comprise one or more of the following features. The rotatable member may be threaded. The vertical extension member may be threaded. The vertical extension member may be arced. The rotatable member may comprise a channel at least partially therethrough that is configured to receive a tool that facilitates rotation of the rotatable member. The first side bow component and the second side bow component each may comprise a slot configured to receive a protrusion of the auxiliary first side bow component and the auxiliary second side bow component, respectively. The rotatable member and the vertical extension member may comprise a plurality of complementary teeth and notches. The declination angle adjuster may be further configured to couple a light thereto.

Implementations of an eyewear system may comprise an eyewear frame comprising a first side bow component and a second side bow component, an auxiliary frame comprising an auxiliary top bar, an auxiliary first side bow component and an auxiliary second side bar component, the auxiliary first side bow component and the auxiliary second side bow component pivotally coupled to the first side bow component and the second side bow component, respectively. The system may further comprise a declination angle adjuster positioned proximal a bridge of the eyewear frame and a vertical extension member extending from the eyewear frame and at least partially into the declination angle adjuster, the vertical extension member comprising an arced shape and configured to change an angle of a lens of the eyewear frame relative to the auxiliary first and second side bow components when the length of the vertical extension member within the declination angle adjuster changes.

Particular aspects may comprise one or more of the following features. The declination angle adjuster may comprise a rotatable member therein. The rotatable member may be configured to engage the vertical extension member. The rotatable member and the vertical extension member may be threaded. The first side bow component and the second side bow component each may comprise a slot configured to receive a protrusion of the auxiliary first side bow component and the auxiliary second side bow component, respectively.

Implementations of a method of changing a declination angle of an eyewear frame may comprise changing a portion of a length of a vertical extension member of an eyewear frame that extends within a declination angle adjuster positioned proximal a bridge of the eyewear frame and pivoting a first side bow component and a second side bow component relative to an auxiliary first side bow component and an auxiliary second side bow component, the auxiliary first side bow component and the auxiliary second side bow components coupled to an auxiliary top bar, wherein the pivoting is in response to the changing of the portion of the length of the vertical extension member of the eyewear frame that is within the declination angle adjuster.

Particular aspects may comprise one or more of the following features. Changing the portion of the length of the vertical extension member may comprise rotating a rotatable member within the declination angle adjuster. The rotatable member may be threaded. The vertical extension member may be threaded. The rotatable member and the vertical extension member may comprise a plurality of complementary teeth and notches. The method may further comprise inserting a tool into a channel extending at least partially through the rotatable member. The method may further comprise coupling a light to the declination angle adjuster.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Brief Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein. Elements and acts in the figures are illustrated for simplicity and have not necessarily been rendered according to any particular sequence or embodiment.

FIGS. 1-4 depict an implementation of an eyewear system.

FIGS. 5-6 provide cross-sectional views of the eyewear system of FIGS. 1-4.

FIGS. 7-8 depict an implementation of an eyewear system comprising a light.

### DETAILED DESCRIPTION

This disclosure, its aspects and implementations, are not limited to the specific components or assembly procedures disclosed herein. Many additional components and assembly procedures known in the art consistent with the intended eyewear systems and/or assembly procedures for eyewear will become apparent for use with implementations of the eyewear systems of this disclosure. Accordingly, for example, although particular eyewear systems are disclosed, such eyewear systems and implementing components may comprise any shape, size, style, type, model, version, measurement, concentration, material, quantity, and/or the like as is known in the art for such eyewear systems and implementing components, consistent with the intended operation of eyewear.

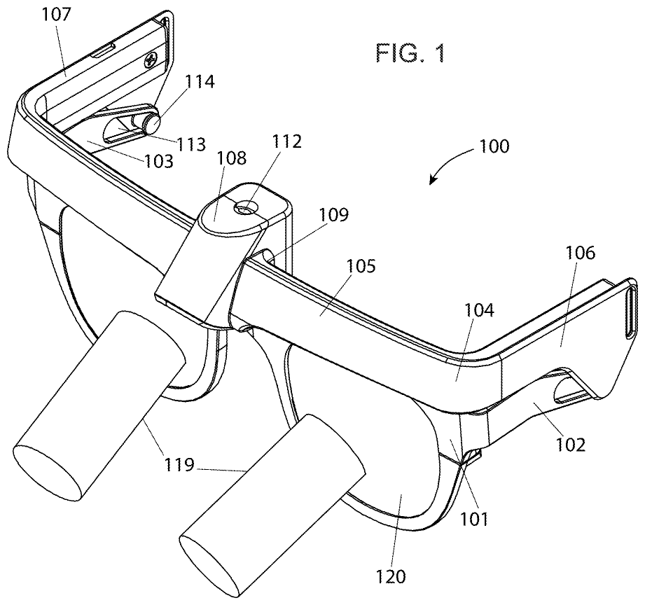

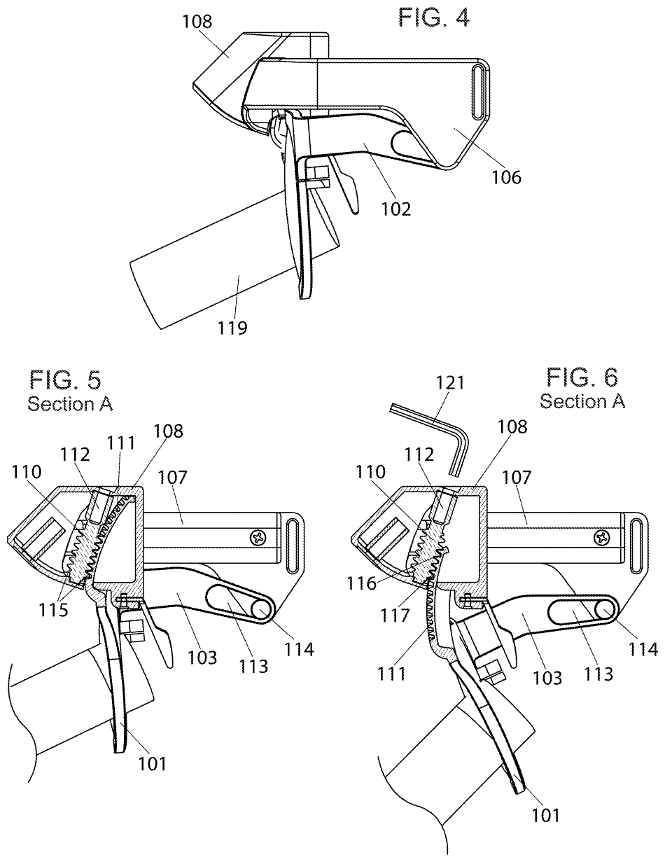

FIGS. 1-8 depict an implementation of an eyewear system 100 comprising a declination angle adjuster 108. Traditionally, when a user desires a change in the declination angle of the eyewear lenses 120, the user must adjust the angle at which the bows contact the user's head proximal the user's ears which results in an unstable and uncomfortable fit of the overall eyewear frame 101. The declination angle adjuster 108 of FIGS. 1-8 is configured to allow a user to simultaneously adjust the declination angle of the eyewear lenses 120 without the need to adjust the positioning of the bows of the eyewear frame 101 that are in contact with the sides of a user's head thereby creating a securely fitting, stable, and comfortable eyewear system 100, particularly when the eyewear system 100 also supports the added weight of one or more loupes 119 coupled to one or more lenses 120 of the eyewear system 100. While the declination angle adjuster 108 is shown here positioned proximal to the bridge 109 of the eyewear frame 101, it may be located anywhere along the eyewear frame 101. In addition to the top bar of the eyewear frame 101 that holds the lenses 120 in place and the side bow components 102, 103 of the eyewear frame 101, the eyewear system 100 comprises an auxiliary frame having an auxiliary top bar 105 and auxiliary first and second side bow components 106, 107. The first and second side bow components 102, 103 of the eyewear frame 101 are pivotably coupled to and are configured to move independently of the auxiliary side bow components 106, 107 such that the declination angle of eyewear frame 101 may be adjusted independently without movement of the auxiliary top bar 105 and auxiliary side bow components 106, 107. As shown in FIG. 1, this may be accomplished using a slot 113 in the first and second side bow components 102, 103 of the eyewear frame or the auxiliary first and second side bow components 106, 107 that is configured to mate with a protrusion 114 of the first and second side bow components 102, 103 or the auxiliary first and second side bow components 106, 107. The first and second auxiliary side bow components 106, 107 maybe configured to couple to additional bow elements and/or a strap or other device configured to secure the eyewear system to the user's head when in use.

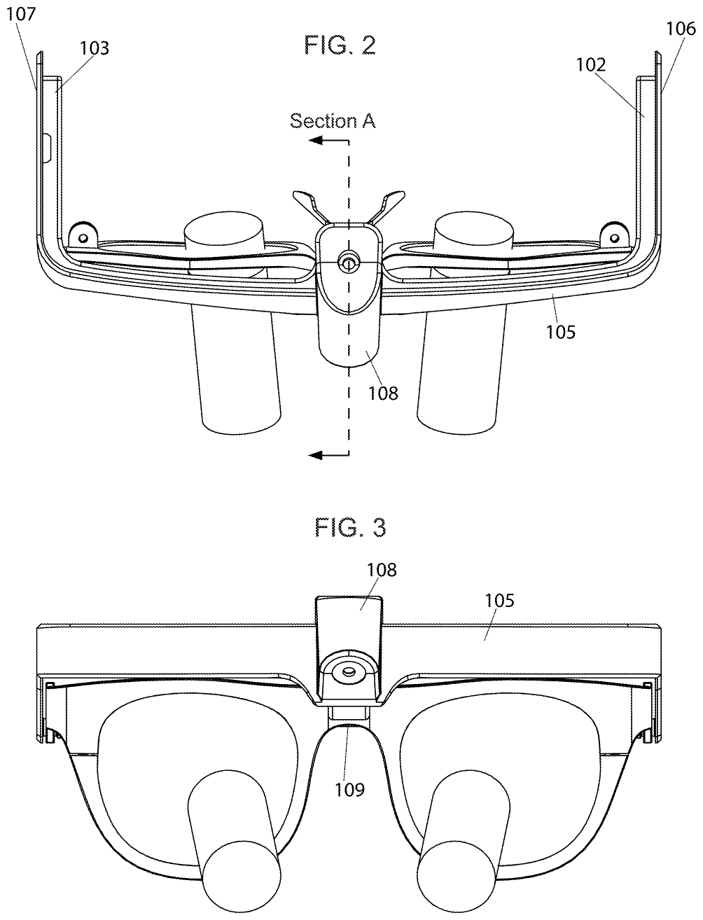

FIGS. 5-6 provide cross-sectional views along Section A of the declination angle adjuster 108 of FIG. 2. The top bar of the eyewear frame 101 comprises a vertical extension member 111 comprising a slight arc along the vertical extension member 111 and comprising a plurality of teeth 116, protrusions, notches 117, or threads 115 along the outer surface of the vertical extension member 111. When a user desires a change in the declination angle of the eyewear frame 101, the user simply adjusts the positioning of the vertical extension member 111 by rotating a rotatable member 110 to raise or lower the vertical extension member 111. This may be accomplished by inserting a tool 121 into a channel 112 extending at least partially into the rotatable member 110, the channel 112 configured to receive the tool 121 to facilitate rotation of the rotatable member 110. When only a slight change in the declination angle is achieved, the number of teeth, protrusions, notches, or threads of the vertical extension that are engaged with the corresponding teeth 116, protrusions, notches 117, or threads 115 of the rotatable member of the declination angle adjuster remain unchanged or only slightly changed. When a greater change to the declination angle is achieved, the rotatable member 110 may be sufficiently rotated to engage more or fewer teeth 116, protrusions, notches 117, or threads 115 of the vertical extension member 111 with the corresponding teeth 116, protrusions, notches 117, or threads 115 in the rotatable member of the declination angle adjuster 108 as shown in FIGS. 5-6. In other embodiments, rather than using a rotatable member 110, the vertical extension member 111 may be held in place using a clamping mechanism or other appropriate securing mechanism within the tension adjuster.

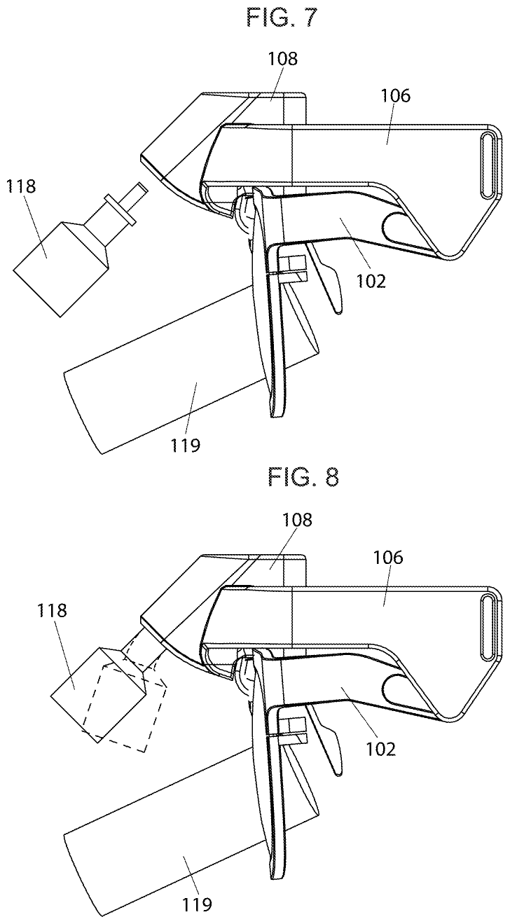

In some implementations, as shown in FIGS. 7-8, the eyewear system 100 may be configured to allow the optional placement of a light 118 on the declination angle adjuster 108 or auxiliary top bar 105. In some implementations, when inserted, the light 118 may be connected to an internal electrical system. Alternatively, the light 118 may be powered by a battery within the light housing. The light may also have an adjustable declination angle which may be achieved using a metal wire core that retains its shape and positioning until sufficient force is applied to change the shape and positioning of the metal wire core; however other suitable materials and structures may also be used to allow for adjustment of the positioning and declination angle of the light 118.

It will be understood that implementations are not limited to the specific components disclosed herein, as virtually any components consistent with the intended operation of a method and/or system implementation for eyewear may be utilized. Accordingly, for example, although eyewear systems may be disclosed, such components may comprise any shape, size, style, type, model, version, class, grade, measurement, concentration, material, weight, quantity, and/or the like consistent with the intended operation of a method and/or system implementation for eyewear may be used. In places where the description above refers to particular implementations of eyewear, it should be readily apparent that a number of modifications may be made without departing from the spirit thereof and that these implementations may be applied to other eyewear systems.

We claim:

1. An eyewear system comprising:
an eyewear frame comprising a first side bow component and a second side bow component;
an auxiliary frame comprising an auxiliary top bar, an auxiliary first side bow component and an auxiliary second side bar component, the auxiliary first side bow component and the auxiliary second side bow component pivotally coupled to the first side bow component and the second side bow component, respectively;
a declination angle adjuster positioned proximal a bridge of the eyewear frame, the declination angle adjuster comprising a rotatable member therein; and
a vertical extension member extending from the eyewear frame and at least partially into the declination angle adjuster, the vertical extension member configured to engage the rotatable member within the declination angle adjuster.

2. The eyewear system of claim 1, wherein the rotatable member is threaded.

3. The eyewear system of claim 2, wherein the vertical extension member is threaded.

4. The eyewear system of claim 1, wherein the vertical extension member is arced.

5. The eyewear system of claim 1, wherein the rotatable member comprises a channel at least partially therethrough that is configured to receive a tool that facilitates rotation of the rotatable member.

6. The eyewear system of claim 1, wherein the first side bow component and the second side bow component each comprise a slot configured to receive a protrusion of the auxiliary first side bow component and the auxiliary second side bow component, respectively.

7. The eyewear system of claim 1, wherein the rotatable member and the vertical extension member comprise a plurality of complementary teeth and notches.

8. The eyewear system of claim 1, wherein the declination angle adjuster is further configured to couple a light thereto.

9. An eyewear system comprising:
an eyewear frame comprising a first side bow component and a second side bow component;
an auxiliary frame comprising an auxiliary top bar, an auxiliary first side bow component and an auxiliary second side bar component, the auxiliary first side bow component and the auxiliary second side bow component pivotally coupled to the first side bow component and the second side bow component, respectively;
a declination angle adjuster positioned proximal a bridge of the eyewear frame; and
a vertical extension member extending from the eyewear frame and at least partially into the declination angle adjuster, the vertical extension member comprising an arced shape and configured to change an angle of a lens of the eyewear frame relative to the auxiliary first and second side bow components when the length of the vertical extension member within the declination angle adjuster changes.

10. The eyewear system of claim 9, wherein the declination angle adjuster comprises a rotatable member therein.

11. The eyewear system of claim 10, wherein the rotatable member is configured to engage the vertical extension member.

12. The eyewear system of claim 11, wherein the rotatable member and the vertical extension member are threaded.

13. The eyewear system of claim 9, wherein the first side bow component and the second side bow component each comprise a slot configured to receive a protrusion of the auxiliary first side bow component and the auxiliary second side bow component, respectively.

14. A method of changing a declination angle of an eyewear frame, the method comprising:
changing a portion of a length of a vertical extension member of an eyewear frame that extends within a declination angle adjuster positioned proximal a bridge of the eyewear frame; and
pivoting a first side bow component and a second side bow component relative to an auxiliary first side bow component and an auxiliary second side bow component, the auxiliary first side bow component and the auxiliary second side bow components coupled to an auxiliary top bar, wherein the pivoting is in response to the changing of the portion of the length of the vertical extension member of the eyewear frame that is within the declination angle adjuster.

15. The method of claim 14, wherein changing the portion of the length of the vertical extension member comprises rotating a rotatable member within the declination angle adjuster.

16. The method of claim 15, wherein the rotatable member is threaded.

17. The method of claim 16, wherein the vertical extension member is threaded.

18. The method of claim 15, wherein the rotatable member and the vertical extension member comprise a plurality of complementary teeth and notches.

19. The method of claim 15, further comprising inserting a tool into a channel extending at least partially through the rotatable member.

20. The method of claim 14, further comprising coupling a light to the declination angle adjuster.
